(19) United States
(12) Patent Application Publication
(10) Pub. No.: US 2009/0274020 A1
(43) Pub. Date: Nov. 5, 2009

(54) OPTICAL HEAD UNIT AND OPTICAL INFORMATION RECORDING/REPRODUCING APPARATUS

(75) Inventor: Ryuichi Katayama, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/312,706

(22) PCT Filed: Nov. 14, 2007
(86) PCT No.: PCT/JP2007/072097

§ 371 Date: May 22, 2009

(30) Foreign Application Priority Data
Nov. 24, 2006 (JP) 2006-317324

(51) Int. Cl. G11B 7/125; G11B 7/135

(52) U.S. Cl. 369/44.23; 369/112.24; 369/112.02; G9B/7.098; G9B/7.112

(57) ABSTRACT

An optical head unit is configured as an optical head unit corresponding to an optical recording medium of BD standard, and an optical recording medium of HD DVD standard. A magnification-variable lens includes convex lens, concave lens, and convex lens. The magnification-variable lens allows each lens to be movable along the optical axis direction, and has the function of changing the ratio of diameter of light incident from the convex lens to the diameter of light that exits from the convex lens within a specific ratio. The magnification-variable lens emits light having a diameter corresponding to the numerical aperture, 0.85, of the objective lens towards the objective lens upon recording/reproducing on a disk of BD standard, and emits light having a diameter corresponding to the numerical aperture, 0.65, of the objective lens upon recording/reproducing on a disk of HD DVD standard.

### TECHNICAL FIELD

The present invention relates to an optical head unit and an optical information recording/reproducing apparatus and, more particularly, to an optical information recording/reproducing apparatus that performs recording/reproducing on optical recording media of a plurality of standards, and to an optical head unit used in such an optical information recording/reproducing apparatus.

### BACKGROUND ART

The optical information recording/reproducing apparatus that performs recording/reproducing on an optical recording medium is widely used. Although there exist a recording/reproducing apparatus that performs the recording and reproducing and a dedicated reproducing apparatus that performs only the reproducing, these apparatuses are collectively referred to as optical recording/reproducing apparatuses herein. The recording density of the optical information recording/reproducing apparatus is inversely proportional to the square of diameter of a focused spot that the optical head unit forms on the optical recording medium. That is, a smaller diameter of the focused spot raises the recording density. The diameter of the focused spot is proportional to the wavelength of a light source in the optical head unit, and inversely proportional to the numerical aperture of the objective lens. That is, a shorter wavelength of the light source as well as a higher numerical aperture of the objective lens reduces the diameter of the focused spot.

For example, with respect to an optical recording medium of CD (compact disk) standard having a capacity of 650 MB, an optical head unit having a wavelength of 780 nm in the light source and a numerical aperture of 0.45 in the objective lens is used. With respect to an optical recording medium of DVD (digital versatile disk) standard having a capacity of 4.7 GB, an optical head unit having a wavelength of 650 nm in the light source and a numerical aperture of 0.6 in the objective lens is used. On the other hand, an HD DVD (high-density digital versatile disk) standard having a capacity of 15 GB to 20 GB and a BD (blu-ray disk) standard having a capacity of 23.3 GB to 27 GB are proposed in recent years, as the optical recording media having a higher recording density. For these standards having a higher recording density, an optical head unit having a shorter wavelength in the light source and a higher numerical aperture in the objective lens is used. More specifically, the wavelength of the light source for both the standards is 405 nm, and the numerical aperture of the objective lens is 0.65 for the HD DVD standard and 0.85 for the BD standard. It is desired that the optical information recording/reproducing apparatus perform both the recoding and reproducing on a plurality of types of the optical recording media having different standards, such as the optical recording media of HD DVD standard and BD standard. Thus, an optical head unit and an optical information recording/reproducing apparatus are desired which have a compatible function for the plurality of standards.

There is an optical head unit described in Patent Publication-1, as the optical head units which can perform the recording and reproducing on any of an optical recording medium of HD DVD standard and an optical recording medium of BD standard. FIG. 12 shows the configuration of the optical head unit described in Patent Publication-1. In this optical head unit 200, a part of light emitted from a semiconductor laser (LD) 201 configured as the light source passes through a diffraction optical element 227 as a zero-order light, then passes through a liquid-crystal optical element 228, and is focused by an objective lens 207 onto a disk 208 that is the optical recording medium. Reflected light from the disk 208 passes through the objective lens 207 and liquid-crystal optical element 228 in the backward direction, then a part thereof is diffracted by the diffraction optical element 227 to configure ±1st-order diffracted lights, whereby +1st-order diffracted light and −1st-order diffracted light are received by photodetectors 211a and 211b, respectively.

For the HD DVD standard and BD standard, the objective lens used for recording and reproducing thereon has different numerical apertures. Thus, in order for the optical head unit to handle both the standards, it is needed to control the numerical aperture of the objective lens depending on the type of the optical recording medium. An optical recording medium of HD DVD and an optical recording medium of BD standard have different thicknesses therebetween in the protective layer (cover layer). More specifically, the protective layer in the HD DVD standard is 0.6 mm thick, whereas the cover layer in the BD standard is 0.1 mm thick. The difference of the protective layer thickness between the optical recording media results in a difference of the spherical aberration generated in the focused spot on the optical recording media. If the spherical aberration generated in the focused spot is large, the shape of the focused spot is disturbed to thereby degrade the recording/reproducing characteristic. For preventing this degradation of the recording/reproducing characteristic, it is needed to correct the spherical aberration depending on the types of the optical recording media so that a change of the protective layer thickness does not incur the spherical aberration on the focused spot.

Correction of the spherical aberration can be performed by changing the magnification factor of the objective lens (corresponding to the degree of divergence or convergence of light incident onto the objective lens) depending on the type of the optical recording medium. In the optical head unit 200 shown in FIG. 12, the objective lens 207 is designed for an optical recording medium of BD standard so that the spherical aberration is corrected when a divergent light having a first divergence angle is incident onto the objective lens 207. On the other hand, it is designed for an optical recording medium of HD DVD so that the spherical aberration is corrected when a divergent light having a second divergence angle is incident onto the objective lens 207.

The liquid-crystal optical element 228 has the functions of controlling the numerical aperture of the objective lens and correcting the spherical aberration depending on the type of the optical recording medium. If the disk 208 is an optical medium of BD standard, the liquid-crystal optical element 228 allows the incident light to pass therethrough toward the objective lens 207 as it is. Thereby, the numerical aperture of the objective lens 207 is set at 0.85 that is determined by the diameter of effective area of the objective lens 207 itself. The light that exits from the liquid-crystal optical element 228 is incident onto the objective lens 207 as a divergent light having the first divergence angle, whereby the spherical aberration is corrected with respect to the disk 208 of BD standard.

On the other hand, if the disk 208 is an optical recording medium of HD DVD standard, the liquid-crystal optical element 228 functions as a concave lens with respect to light incident onto the interior of a circular area of the objective lens 207 corresponding to the numerical aperture 0.65, and functions to completely diffract the incident light that is incident onto the exterior of the circular area. As a result, the light that exits from the interior of the circular area of the liquid-crystal optical element 228 is incident onto the objective lens 207 as a divergent light having the second divergence angle, whereas the light that exits from the exterior of the circular area is not incident as an effective light to the objective lens 207. This allows the numerical aperture of the objective lens 207 to assume 0.65 that is determined by the diameter of circular area of the liquid-crystal optical element. In addition, the spherical aberration is corrected with respect to the disk 208 of HD DVD standard.

Here, the thickness of protective layer of an optical recording medium has a significant range of variation with respect to the design value thereof. If the thickness of protective layer of the optical recording medium has a deviation from the design value, the shape of focused spot is disturbed by the spherical aberration that is attributable to deviation of the thickness of the protective layer, to thereby degrade the recording/reproducing characteristics. Since the spherical aberration is inversely proportional to the wavelength of light source and is proportional to the quadruplicate power of numerical aperture of the objective lens, a shorter wavelength of the light source as well as a higher numerical aperture of the objective lens narrows the margin of deviation of the thickness of the protective layer with respect to the recording/reproducing characteristics. Accordingly, it is needed to correct the spherical aberration attributable to deviation of the protective layer thickness in the optical recording medium in order for preventing degradation of the recording/reproducing characteristics in the optical head unit and optical recording/reproducing apparatus that handle the HD DVD standard and BD standard, wherein the wavelength of light source is reduced and the numerical aperture is increased in order to increase the recording density.

As the optical head units that can correct the spherical aberration attributable to deviation of the protective layer thickness in the optical recording medium, there is one described in Patent Publication-2. FIG. 13 shows the configuration of the optical head unit described in Patent Publication-2. In this optical head unit 300, the light emitted from a semiconductor laser 301 that configures the light source is converted in the sectional shape thereof from an elliptical shape to a circular shape, and then collimated by a collimator lens 302. Thereafter, a part of light penetrates abeam splitter 330, then passes through a concave lens 331a and a convex lens 331b, and is focused by an objective lens 307 onto a disk 308 that is the optical recording medium. The reflected light from the disk 308 passes through the objective lens 307, convex lens 331b and concave lens 331a in the backward direction, and a part thereof is reflected by the beam splitter 330 and passes through a cylindrical lens 309 and a convex lens 310, to be received by a photodetector 311.

Correction of the spherical aberration attributable to deviation of the protective layer thickness in the optical recording medium can be performed by changing the magnification factor of the objective lens 307 depending on the amount of deviation of the protective layer thickness. If the protective layer thickness of the disk 308 is equal to the design value, the objective lens 307 is designed so that the spherical aberration is corrected upon incidence of a parallel light. The concave lens 331a and convex lens 331b are used to correct the spherical aberration attributable to deviation of the protective layer thickness. If the protective layer thickness of the disk 308 is equal to the design value, a parallel light is incident onto the objective lens 307 by employing a specific design value for the distance between the concave lens 331a and the convex lens 331b. This provides correction of the spherical aberration.

If the protective layer thickness of the disk 308 is smaller than the design value, the distance between the concave lens 331a and the convex lens 331b is increased from the specific design value by an amount that is dependent on deviation of the protective layer thickness. This causes the light incident onto the objective lens 307 to assume a converged light having a convergence angle that is dependent on deviation of the protective layer thickness. If the protective layer thickness of the disk 306 is larger than the design value, the distance between the concave lens 331a and the convex lens 331b is reduced from the specific design value by an amount that is dependent on deviation of the protective layer thickness. This causes the light incident onto the objective lens 307 to assume a divergent light having a divergence angle that is dependent on deviation of the protective layer thickness. In this way, the spherical aberration attributable to deviation of the protective layer thickness is corrected.

The distance between the concave lens 331a and the convex lens 331b can be changed by moving either one of the concave lens 331a and convex lens 331b along the optical axis direction. On the other hand, the optical head unit 300 shown in FIG. 13 includes a mechanism that moves both the concave lens 331a and convex lens 331b along the optical axis direction. In this way, the movement of either one of the concave lens 331a and convex lens 331b along the optical axis direction can correct the spherical aberration, and the movement of the other along the optical axis direction can correct a coma aberration that is attributable to a shift of the objective lens 307 in the direction perpendicular to the optical axis.

The amount of movement of the concave lens 331a and convex lens 331b during correcting the spherical aberration attributable to deviation of the protective layer thickness of the disk 308 as well as the coma aberration attributable to shift of the objective lens 307 in the direction perpendicular to the optical axis is as small as about ±100 micrometer in general. For this reason, even if the concave lens 331a and convex lens 331b are moved along the optical axis direction, the beam diameter of light incident onto the objective lens 307 is not substantially changed.

Patent Publication-1; JP-1998-92003A

Patent Publication-2; JP-2005-293775A

In the optical head unit 200 shown in FIG. 12, if the disk 208 is an optical recording medium of BD standard, the effective light which contributes to the recording/reproducing is the light which is incident onto the interior of effective area of the objective lens 207. On the other hand, if the disk 208 is an optical recording medium of HD DVD standard, the effective light that contributes to the recording/reproducing is the light incident onto the interior of the circular area of the liquid-crystal optical element 228. In either case, in order to obtain the focused spot on the diffraction limit corresponding to the numerical aperture of the objective lens 207, light is incident onto all over the interior of the area corresponding to the numerical aperture of the objective lens 207. In this case, since the diameter of circular area of the liquid-crystal optical element 228 is smaller than the diameter of effective area of the objective lens 207, the amount of effective light (effective light quantity) that contributes to the recording/reproducing on the optical recording medium of HD DBD standard is smaller as compared to the effective light quantity in an optical recording medium of BD standard. That is, there is the problem in the optical head unit 200 that the utilization efficiency of light with respect to an optical recording medium of HD DVD standard is lower as compared to the utilization efficiency of light with respect to an optical recording medium of BD standard. Thus, although the effective light quantity needed for the reproducing can be obtained with respect to an optical recording medium of HD DVD standard in an recording/reproducing apparatus using the optical head unit 200, the effective light quantity needed for the recording cannot be obtained.

The optical head unit 300 shown in FIG. 13 performs adjustment of the distance between the concave lens 311a and the convex lens 331b to correct the spherical aberration attributable to deviation of the protective layer thickness, and is not configured as an optical head unit that handles both an optical recording medium of HD DVD standard and an optical recording medium of BD standard. In addition, the configuration wherein the distance between the concave lens 311a and the convex lens 331b is adjusted to form the light incident onto the objective lens 307 as a divergent light, parallel light, or convergent light cannot solve the above problem that the utilization efficiency of light is poor with respect to an optical recording medium of HD DVD standard.

### SUMMARY OF THE INVENTION

It is an object of the present invention to provide an optical head unit and an optical recording/reproducing apparatus that are capable of obtaining a higher utilization efficiency of light with respect to optical recording media of any standards during recording/reproducing on a plurality of types of optical recording media of different standards.

The present invention provides an optical head unit for use in recording/reproducing on a plurality of types of optical recording medium for which different optical conditions are used in the recording/reproducing, the optical head unit including: a light source; an objective lens that focuses light from the light source to form a focused spot on an optical recording medium including a track; a functional lens disposed between the light source and the objective lens and having a function of changing a diameter of light incident onto the objective lens; and a photodetector that receives light reflected from the optical recording medium, wherein the functional lens is controlled depending on the type of the optical recording medium to be used, thereby controlling the diameter of an optical beam incident onto the objective lens.

The optical information recording/reproducing apparatus of the present invention features including: the above optical head unit of the present invention; a first circuit first block that drives the light source; a second circuit block that detects an RF signal recorded on the optical recording medium based on an output from the photodetector; a third circuit block that drives the functional lens so that the diameter of the optical beam changes depending on a type of the optical recording medium to be used; and a fourth circuit block that detects a focus error signal that represents a positional deviation of the focused spot along the optical axis direction with respect to the track and a tracking error signal that represents a positional deviation of the focused spot perpendicular to the track within a plane perpendicular to the optical axis based on the output from the photodetector, and drives the objective lens based on the focus error signal and the tracking error signal.

The above and other objects, features and advantages of the present invention will be more apparent from the following description, referring to the drawings.

### BRIEF DESCRIPTION OF THE DRAWINGS

FIG. 1 is a block diagram showing the configuration of an optical head unit according to a first exemplary embodiment of the present invention.

FIGS. 2A and 2B are sectional views each showing the sectional structure of the liquid-crystal optical element in FIG. 1.

FIGS. 3A and 3B are sectional views showing a first example of the magnification-variable lens.

FIGS. 4A and 4B are sectional views showing a second example of the magnification-variable lens.

FIG. 5 is a block diagram showing the configuration of an optical information recording/reproducing apparatus including the optical head unit shown in FIG. 1.

FIG. 6 is a block diagram showing the configuration of an optical head unit according to a second exemplary embodiment of the present invention.

FIG. 7 is a block diagram showing the configuration of an optical information recording/reproducing apparatus including the optical head unit shown in FIG. 6.

FIG. 8 is a sectional view showing a third example of the magnification-variable lens.

FIG. 9 is a sectional view showing a fourth example of the magnification-variable lens.

FIG. 10 is a block diagram showing the configuration of an optical head unit according to a third exemplary embodiment of the present invention.

FIGS. 11A and 11B are sectional views showing an example of the collimating lens.

FIG. 12 is a block diagram showing the configuration of the optical head unit described in Patent Publication-1.

FIG. 13 is a block diagram showing the configuration of the optical head unit described in Patent Publication-2.

### BEST MODE FOR CARRYING OUT THE INVENTION

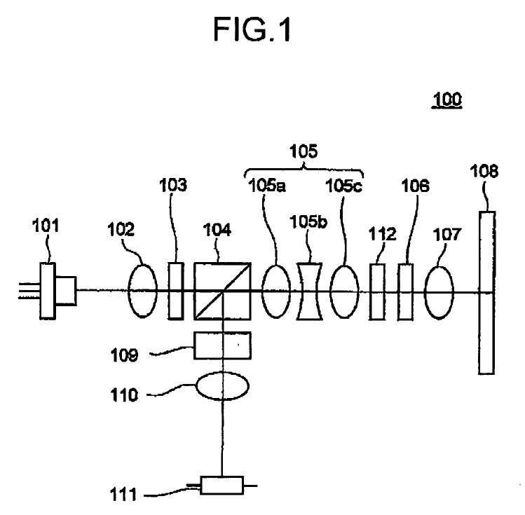

Hereinafter, embodiments of the present invention will be described in detail with reference to the drawings. FIG. 1 shows the configuration of an optical head unit according to a first exemplary embodiment of the present invention. The optical head unit 100 includes a semiconductor laser 101, a collimating lens 102, a diffraction optical element 103, a polarization beam splitter 104, a magnification-variable lens 105, a ¼-wavelength plate 106, an objective lens 107, cylindrical lens 109, a convex lens 110, a photodetector 111, and a liquid-crystal optical element 112. The optical head unit 100 is configured as an optical head unit that is capable of performing recording and reproducing with respect to any of an optical recording media of HD DVD standard and an optical recording medium of BD standard.

The magnification-variable lens 105 is configured as a lens system having the function of changing the diameter of light incident onto the objective lens 107. The magnification-variable lens 105 has the function of changing the diameter of an optical beam that is emitted thereto from the semiconductor laser 101 configured as the light source, and the diameter of an optical beam that exits therefrom toward the objective lens 107. The magnification-variable lens 105 includes three lens groups: a lens group that functions as a convex lens, a lens group that functions as a concave lens, and a lens group that functions as another convex lens. Each lens group is configured by a single lens. That is, the lens group that functions as the convex lens is configured by a single convex lens 105a, the lens group that functions as the concave lens is configured by a single concave lens 105b, and the lens group that functions as the convex lens is configured by a single convex lens 105c.

The semiconductor laser 101 is configured as the light source. The collimating lens 102 collimates the light emitted from the semiconductor laser 101. The diffraction optical element 103 receives the light collimated by the collimating lens 102, and divides the received light into three lights including a zero-order light that is a main beam, and +first-order lights that are subordinate beams. These lights are incident onto the polarization beam splitter 104 as P-polarized lights, and pass through the polarization beam splitter 104 almost completely. The magnification-variable lens 105 receives the light that passed through the polarization beam splitter 104, and changes the diameter of beam spot by a specific magnification factor. Operation of this magnification-variable lens 105 will be described later.

The liquid-crystal optical element 112 has the functions of controlling the numerical aperture of the objective lens and correcting the spherical aberration depending the type of the optical recording medium. The light that exits from the magnification-variable lens 105 and passed through the liquid-crystal optical element 112 is converted from a linearly-polarized light into a circularly-polarized light by the ¼-wavelength plate 106, is incident onto the objective lens 107, and is focused by the objective lens 107 onto a disk 108 that is the optical recording medium. The objective lens 107 is designed for an optical recording medium of BD standard such that the spherical aberration is corrected when a collimated light is incident onto the objective lens 107, and designed for an optical recording medium of HD DVD standard such that the spherical aberration is corrected when a divergent light having a specific divergence angle is incident onto the objective lens 107.

The reflected light of the main beam and the reflected light of the subordinate beams, which are reflected by the disk 108, pass through the objective lens 107 in the backward direction, and are converted by the ¼-wavelength plate 106 from the circularly-polarized light into a linearly-polarized light, the polarization direction of which is perpendicular to that in the forward path, to pass through the liquid-crystal optical element 112 in the backward direction. Thereafter, these lights pass through the magnification-variable lens 105, to be incident onto the polarization beam splitter 104 as S-polarized lights, and are reflected thereby almost completely, to travel toward the cylindrical lens 109. The reflected lights from the disk 108 are incident onto the photodetector 111 via the cylindrical lens 109 and convex lens 110, to be converted into an electric signal at the photoreceiving parts of the photodetector 111. In the optical head unit 100, a focus error signal, a tracking error signal, and an RF signal that is recorded on the disk 108 are detected based on the output from the photoreceiving parts of the photodetector 111. The focus error signal is detected using a known astigmatic technique, whereas the tracking error signal is detected using a known phase shift technique or differential push-pull technique.

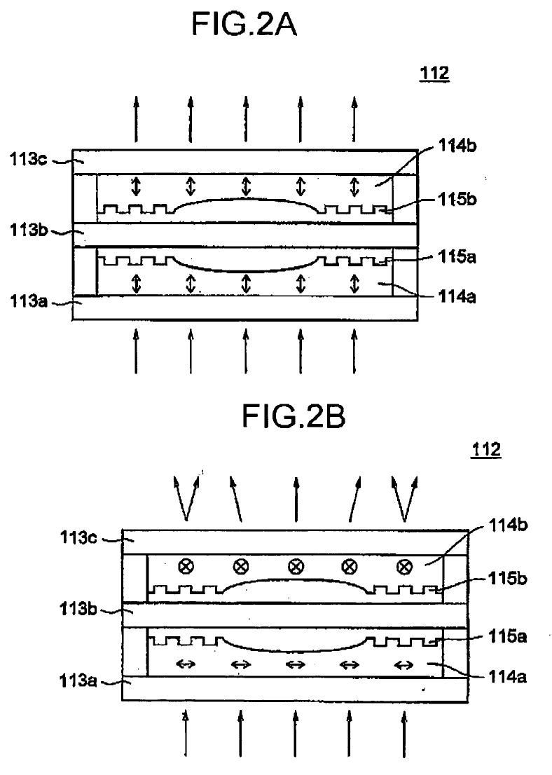

FIGS. 2A and 23 show the sectional structure of the liquid-crystal optical element 112. The liquid-crystal optical element 112 includes three glass substrates 113a, 113b and 113c. Liquid crystal polymer 114a and filling agent 115a are encapsulated between glass substrate 113a and glass substrate 113b, whereas the liquid crystal polymer 114b and filling agent 115b are encapsulated between glass substrates 113b and glass substrate 113c. At the boundary between the liquid crystal polymer 114a and the filling agent 115a, as well as the boundary between the liquid crystal polymer 114b and the filling agent 115b, there is provided a lens surface within the interior of the circular area corresponding to the numerical aperture, 0.65, of the objective lens 107, the lens surface being convex on the side of the liquid crystal polymer 114a, 114b and concave on the side of the filling agent 115a, 115b.

The liquid crystal polymer 114a, 114b has a uniaxial refractive-index anisotropy. It is assumed that the refractive index of the liquid crystal polymer 114a, 114b is nₑ for the extraordinary light and nₒ for the ordinary light, where nₒ<nₑ. It is also assumed that the refractive index of the filling agent 115a, 115b is equal to the refractive index nₒ of the liquid crystal polymer 114a, 114b with respect to the ordinary light. Although omitted for depiction in FIGS. 2A and 2B, electrodes for driving the liquid crystal polymers are provided on the surface of glass substrate 113a near the liquid crystal polymer 114a, the surface of glass substrate 113b near the filling agent 115a, and the surface of glass substrate 113c near the liquid crystal polymer 114b.

The liquid-crystal optical element 112 is applied with a specific voltage during recording/reproducing on the disk of BD standard between the surface of glass substrate 113a near the liquid crystal polymer 114a and the surface of glass substrate 113b near the filling agent 115a, and between the surface of glass substrate 113c near the liquid crystal polymer 114b and the surface of glass substrate 113b near the filling agent 115b. In the state of application of the voltage, as shown in FIG. 2A, the longitudinal direction of the liquid crystal polymer 114a and liquid crystal polymer 114b is parallel to the optical axis direction of the incident light, whereby the refractive index of the liquid crystal polymer 114a, 114b with respect to the incident light is nₒ irrespective of the polarization direction of the incident light.

In the above state, the lens surface at the boundary between the liquid crystal polymer 114a and the filling agent 115a and the boundary between the liquid crystal polymer 114b and the filling agent 115b does not act as a lens with respect to the incident light, whereby the diffraction grating surface does not act as a diffraction grating with respect to the incident light. That is, the liquid-crystal optical element 112 does not exert any action on the incident light irrespective of the polarization direction of the incident light. As a result, the forward-path light incident onto the liquid-crystal optical element 112 exits as a parallel light from the liquid-crystal optical element 112, and is incident onto the objective lens 107. On the contrary, the backward-path light incident onto the liquid-crystal optical element 112 as a parallel light from the objective lens 107 exits as the parallel light from the liquid-crystal optical element 112, and is incident onto the magnification-variable lens 105. Thereby, both the forward-path light and backward-path light are corrected in the spherical aberration thereof with respect to the disk 108. In this case, the numerical aperture of the objective lens 107 is set at 0.85 that is determined by the diameter of effective area of the objective lens itself.

On the other hand, upon recording and reproducing on a disk 108 of HD DVD standard, the liquid-crystal optical element 112 is not applied with a voltage between the surface of glass substrate 113a near the liquid crystal polymer 114a and the surface of glass substrate 113b near the filling agent 115a as well as between the surface of lass substrate 113c near the liquid crystal polymer 114b and the surface of glass substrate 113b near the filling agent 115b. In the state of absence of applied voltage, as shown in FIG. 2B, the longitudinal direction of the liquid crystal polymer 114a is perpendicular to the optical axis of the incident light and parallel to the sheet of drawing, and the longitudinal direction of liquid crystal polymer 114b is perpendicular to the optical axis of the incident light and perpendicular to the sheet of drawing. In this state, the refractive indexes of the liquid crystal polymers 114a and 114b with respect to the incident light are nₑ and nₒ, respectively, if the polarization direction of the incident light is parallel to the sheet of drawing, whereas the refractive indexes of the liquid crystal polymers 114a and 114b with respect to the incident light is nₒ and nₑ, respectively, if the polarization direction of the incident light is perpendicular to the sheet of drawing.

In the above state, if the polarization direction of the incident light is parallel to the sheet of drawing, the lens surface configured on the boundary between the liquid crystal molecules 114a and the filling agent 115a acts as a concave lens with respect to the incident light, whereby the diffraction grating surface acts as a diffraction grating that completely diffracts the incident light. In addition, the lens surface formed on the boundary between the liquid crystal polymer 114b and the filling agent 115b does not act as a lens with respect to the incident light, whereby the diffraction grating surface does not act as a diffraction grating with respect to the incident light. On the other hand, if the polarization direction of the incident light is perpendicular to the sheet of drawing, the lens surface formed on the boundary between the liquid crystal molecule 114b and the filling agent 115b acts as a concave lens with respect to the incident light, whereby the diffraction grating surface acts as a diffraction grating that completely diffracts the incident light. In addition, the lens surface formed on the boundary between the liquid crystal polymer 114a and the filling agent 115a does not act as a lens with respect to the incident light, whereby the diffraction grating surface does not act as a diffraction grating with respect to the incident light. That is, for both the cases where the polarization direction of the incident light is parallel to and perpendicular to the sheet of drawing, the liquid-crystal optical element 112 acts as a concave lens with respect to the light incident onto the interior of the circular area corresponding to the numerical aperture, 0.65, of the objective lens 107, and acts to completely diffract the light incident onto the exterior of the circular area. As a result, the forward-path light incident onto the liquid-crystal optical element 112 as a parallel light from the magnification-variable lens 105 exits, assuming that the polarization direction thereof is parallel to the sheet of drawing, from the liquid-crystal optical element 112 in the interior of the circular area thereof as a divergent light having a specific divergence angle toward the objective lens 107, and exits from the liquid-crystal optical element 112 in the exterior of the circular area thereof as a collimating light having a specific collimation angle and thus is not incident onto the objective lens 107 as an effective light. On the contrary, the backward-path light incident onto the liquid-crystal optical element 112 as a convergent light having a specific convergence angle from the objective lens 107 exits, assuming that the polarization direction is perpendicular to the sheet of drawing, from the liquid-crystal optical element 112 in the interior of the circular area thereof as a parallel light toward the magnification-variable lens 105, and exits from the liquid-crystal optical element 112 in the exterior of the circular area thereof as a diffracted light and thus is not incident onto the magnification-variable lens 105 as an effective light. This allows both the forward-path light and backward-path light to be corrected in the spherical aberration thereof with respect to the disk 108. In this case, the numerical aperture of the objective lens 107 is set at 0.65 that is determined by the diameter of circular area of the liquid-crystal optical element 112.

Description will be made with respect to the magnification-variable lens 105. The magnification-variable lens 105 includes three lenses including a convex lens 105a, a concave lens 105b, and a convex lens 105c. The ratio of the diameter of the optical beam of the incident light to the diameter of the optical beam of the exiting light is changed by controlling the distance between the convex lens 105a and the concave lens 105b and the distance between the concave lens 105b and the convex lens 105c. Hereinafter, the ratio of the diameter of light incident onto the convex lens 105a from the polarization beam splitter 104 to the diameter of the light exiting from the convex lens 105c to the objective lens 107 is defined as a magnification factor of the magnification-variable lens 105.

Here, if the disk 108 is an optical recording medium of BD standard, the effective light that contributes to the recording/reproducing is a light that is incident onto the interior of effective area of the objective lens 107. On the other hand, if the disk 108 is an optical recording medium of HD DVD standard, the effective light that contributes to the recording/reproducing is a light that is incident onto the interior of the circular area of the liquid-crystal optical element 112. Thus, if the disk 108 is an optical recording medium of BD standard, the magnification factor of the magnification-variable lens 105 is controlled so that the diameter of light exiting from the convex lens 105c toward the objective lens 107 is controlled to correspond to the diameter of the effective area of the objective lens 107. If the disk 108 is an optical recording medium of HD DVD standard, the magnification factor of the magnification-variable lens 105 is controlled so that the diameter of light exiting from the convex lens 105c toward the liquid-crystal optical element 112 is controlled to correspond to the diameter of circular area of the liquid-crystal optical element 112. The ratio of the magnification factor of the magnification-variable lens 105 during using an optical recording medium of BD standard to the magnification factor of the magnification-variable lens 105 during using an optical recording medium of HD DVD standard is set to be substantially equal to the ratio of diameter of the effective area of the objective lens 107 to the diameter of circular area of the liquid-crystal optical element 112.

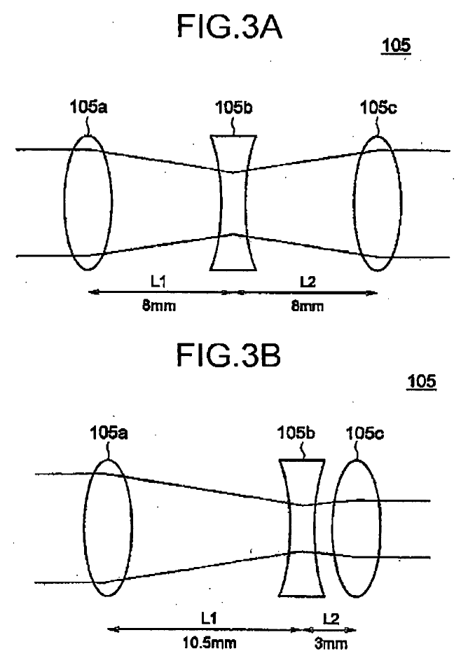

FIGS. 3A and 3B show a first example of the magnification-variable lens. In this example, the diameter of beam incident onto the convex lens 105a is 4 mm. It is assumed that the diameter of effective area of the objective lens 107 is 4 mm and the diameter of circular area of the liquid-crystal optical element 112 is 2 mm. It is assumed that the focal length of the convex lenses 105a and 105c is 18 mm, and the focal length of the concave lens 105b is −5 mm. For the sake of simplification of description, the thickness of each lens is assumed negligible. It is assume that L1 is the distance between the convex lens 105a and the concave lens 105b that configure magnification-variable lens 105, and L2 is the distance between the concave lens 105b and the convex lens 105c, In this example, the position of the convex lens 105a is fixed, and the distances L1 and L2 are to be changed by allowing the concave lens 105b and convex lens 105c to be driven along the optical axis direction.

Upon setting distance between the lenses in the magnification-variable lens 105 such that L1=8 mm and L2=8 mm, as shown in FIG. 3A, the diameter of light incident onto the convex lens 105a as a parallel light exits from the convex lens 105c as the parallel light, and the diameter of the optical beam exiting from the convex lens 105c is 4 mm. That is, the magnification factor of the magnification-variable lens 105 is “1”. Upon using an optical recording medium of BD standard, since the diameter of light incident onto the convex lens 105a is 4 mm, and the diameter of effective area of the objective lens 107 is 4 mm, the distance between the lenses in the magnification-variable lens 105 is controlled, as shown in FIG. 3A, so that the magnification factor is controlled at “1”, thereby allowing the optical beam having a diameter of 4 mm corresponding to the diameter of the effective area of the objective lens to be incident onto the objective lens 107.

Upon setting the distance between the lenses in the magnification-variable lens 105 such that L1=10.5 mm and L2=3 mm, as shown in FIG. 3B, the diameter of light incident onto the convex lens 105a as a parallel light exits from the convex lens 105c as the parallel light, and the diameter of the optical beam exiting from the convex lens 105c is 2 mm in this case. That is, the magnification factor of the magnification-variable lens 105 is set at “0.5”. Upon using an optical recording medium of HD DVD standard, since the diameter of light incident onto the convex lens 105a is 4 mm, and the diameter of circular area of the liquid-crystal optical element 112 is 2 mm, the distances between the lenses in the magnification-variable lens 105 are controlled, as shown in FIG. 3B, so that the magnification factor is controlled at “10.5”, thereby allowing an optical beam having a diameter of 2 mm corresponding to the circular area of the liquid-crystal optical element to be incident onto the liquid-crystal optical element 112.

The optical head unit changes the magnification factor of the magnification-variable lens 105 depending on the type of disk 108 during the recording/reproducing, thereby improving the utilization efficiency of light with respect to the disk 108 that is the target for the recording/reproducing. More specifically, if the disk 108 is an optical recording medium of BD standard, distances L1 and L2 between the lenses in the magnification-variable lens 105 are set at 8 mm and 8 mm (FIG. 3A), respectively, thereby setting the magnification factor of the magnification-variable lens 105 at “1”. On the other hand, if the disk 108 is an optical recording medium of HD DVD standard, distances L1 and L2 between the lenses in the magnification-variable lens 105 are set at 10.5 mm and 3 mm (FIG. 3B), respectively, thereby setting the magnification factor of the magnification-variable lens 105 at “0.5”. In this way, a higher utilization efficiency of light is acquired during recording and reproducing on the optical recording medium of any type.

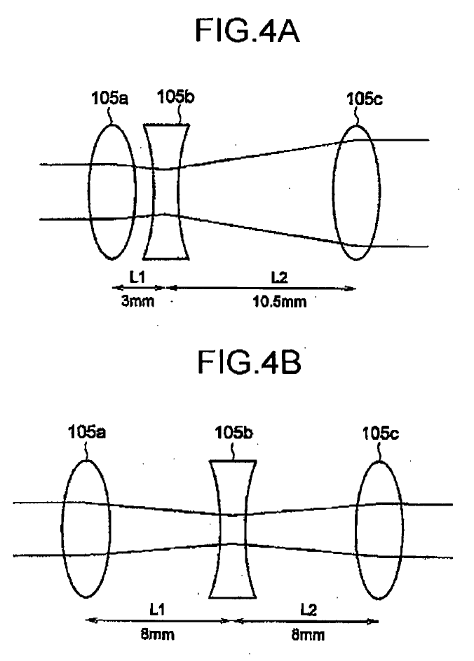

FIGS. 4A and 4B show a second example of the magnification-variable lens 105b. In this example, the diameter of beam incident onto the convex lens 105a is 2 mm. It is assumed again in this example that the diameter of effective area of the objective lens 107 is 4 mm, and the diameter of circular area of the liquid-crystal optical element is 2 mm. The focal length of the convex lenses 105a and 105c is 18 mm, as in the above example, and the focal length of the concave lens 105b is −5 mm. For simplification of the description, the thickness of each lens is assumed negligible.

Upon setting the distances between lenses in the magnification-variable lens 105 such that L1=3 mm and L2=10.5 mm, as shown in FIG. 4A, the diameter of light incident onto the convex lens 105a as a parallel light exits from the convex lens 105c as the parallel light, and the diameter of the optical beam exiting from the convex lens 105c is 4 mm in this case. That is, the magnification factor of the magnification-variable lens 105 is set at “2”. Upon using an optical recording medium of BD standard, since the diameter of light incident onto the convex lens 105a is 2 nm and the diameter of effective area of the objective lens 107 is 4 mm, the distance between lenses in the magnification-variable lens 105 is controlled as shown in FIG. 4A, so that the magnification factor is set at “2”, thereby allowing the optical beam having a diameter of 4 mm to be incident onto the objective lens 107.

Upon setting the distances between lenses in the magnification-variable lens 105 such that L1=8 mm and L2=8 mm, as shown in FIG. 4B, the light incident onto the convex lens 105a as a parallel light exits from the convex lens 105c as the parallel light, and the diameter of optical beam exiting from the convex lens 105c is 2 mm. That is, the magnification factor of the magnification-variable lens 105 is set at “1”. Upon using an optical recording medium of HD DVD standard, since the diameter of effective area of the objective lens 107 is 2 mm, and the diameter of light incident onto the convex lens 105a is 2 mm, the distances between lenses in the magnification-variable lens 105 is controlled, as shown in FIG. 4B, so that the magnification factor of the magnification-variable lens 105 is set at “1”, thereby allowing an optical beam having a diameter of 2 mm to be incident onto the objective lens 107.

In this example, if the disk 108 is an optical recording medium of BD standard, the optical head unit sets the distances L1 and L2 between lenses in the magnification-variable lens 105 at 3 mm and 10.5 mm (FIG. 4A), respectively, thereby setting the magnification factor of the magnification-variable lens 105 at “2”. On the other hand, if the disk 108 is an optical recording medium of HD DVD standard, the distances L1 and L2 between lenses in the magnification-variable lens 105 are set at 8 mm and 8 mm (FIG. 4B), respectively, thereby setting the magnification factor of the magnification-variable lens 105 at “1”. In this way, a higher utilization efficiency of light is again obtained upon recording/reproducing on the optical recording medium of any type.

In the first and second examples, the position of convex lens 105a is fixed among the lenses that configure the magnification-variable lens 105, and the concave lens 105b and convex lens 105c are to be moved along the optical axis direction, thereby changing the magnification factor. As the mechanism that moves the lenses along the optical axis direction, a stepping motor or IDM (smooth impact drive mechanism) can be used. The distance may be adjusted by moving convex lenses 105a and 105c along the optical axis direction with the convex lens 105c being fixed, or may be adjusted by moving the convex lens 105a and concave lens 105b along the optical axis direction with the convex lens 105c being fixed. In the first and second examples, the number of lenses that configure the magnification-variable lens 105 is suppressed to the minimum of three, and in this way the cost of lens itself can be reduced.

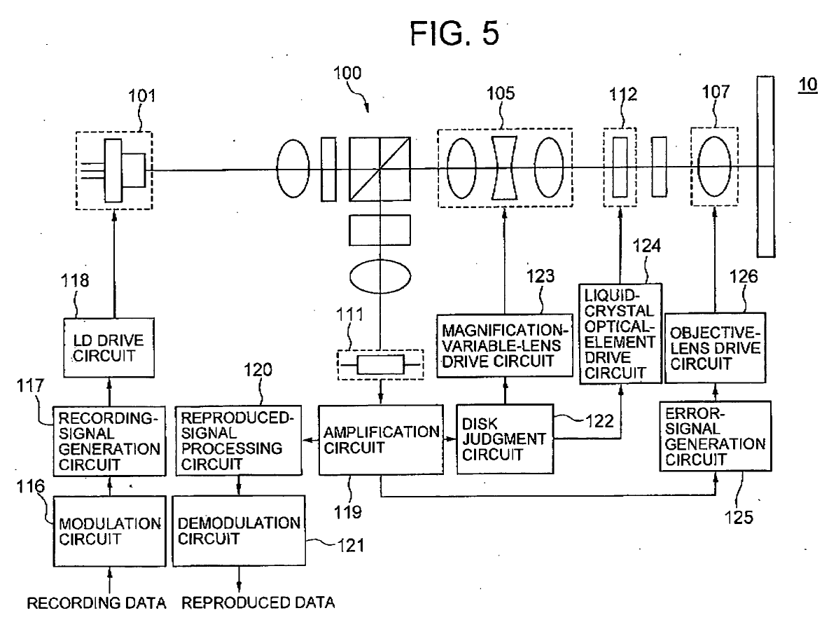

FIG. 5 shows the configuration of an optical information recording/reproducing apparatus including the optical head unit 100 shown in FIG. 1. The optical information recording/reproducing apparatus 10 includes, in addition to the optical head unit 100, a modulation circuit 116, recording-signal generation circuit 117, a semiconductor-laser (LD) drive circuit 118, an amplification circuit 119, are produced-signal processing circuit 120, a demodulation circuit 121, a disk judgment circuit 122, a magnification-variable-lens drive circuit 123, a liquid-crystal optical-element drive circuit 124, an error-signal generation circuit 125, and an objective-lens drive circuit 126.

The modulation circuit 116 modulates the recording data to be recorded on the disk 108 in accordance with a specific modulation rule. The recording-signal generation circuit 117 generates a signal for driving the semiconductor laser 101 based on the signal modulated by the modulation circuit 116 in accordance with a recording strategy. Based on the recording signal generated by the recording-signal generation circuit 117, the semiconductor-laser drive circuit 118 supplies current to the semiconductor laser 101 in accordance with the recording signal, to thereby drive the semiconductor laser 101. In this way, recording is performed on the disk 108. The semiconductor-laser drive circuit 118 corresponds to the first circuit block that drives the light source.

The amplification circuit 119 amplifies the output from each photoreceiving part of the photodetector 111. The reproduced-signal processing circuit 120 generates an RF signal recorded on the disk 108 based on the signal amplified in the amplification circuit 119, and performs waveform equalization and binarization thereto. The demodulation circuit 121 recovers the signal binarized by the reproduced-signal processing circuit 120, in accordance with a specific demodulation rule. Thus, reproducing of the data reproduced from the disk 108 is performed. The amplification circuit 119, reproduced-signal processing circuit 120, and demodulation circuit 121 correspond to the second circuit block that detects based on the output from the photodetector 111 the RF signal recorded on the optical recording medium.

The disk judgment circuit 122 judges whether the disk 108 is an optical recording medium of BD standard or an optical recording medium of HD DVD standard, based on the signal amplified in the amplification circuit 119. The magnification-variable-lens drive circuit 123 drives the magnification-variable lens 105 based on the type of the disk 108 judged by the disk judgment circuit 122 so that the magnification factor of the magnification-variable lens 105 has the specific value. More specifically, the stepping motor or SIDM is supplied with current to control the distance between the lenses for setting the magnification factor at the specific value. The magnification-variable-lens drive circuit 123 corresponds to the third circuit block that drives the lenses.

The liquid-crystal optical-element drive circuit 124 drives the liquid-crystal optical element 112 based on the type of disk 108 judged by the disk judgment circuit 122. More specifically, the voltage supplied to the liquid-crystal optical element 112 is controlled in accordance with the type of disk 108 to control the magnification factor and numerical aperture of the liquid-crystal optical element 112 at the value corresponding to the type of disk 108.

The error-signal generation circuit 125 generates the focus error signal and tracking error signal based on the signal amplified in the amplification circuit 119. The objective-lens drive circuit 126 drives the objective lens 107 based on the error signal generated by the error-signal generation circuit 125. More specifically, a current corresponding to the error signal is supplied to the actuator for driving the objective lens 107, to thereby drive the objective lens 107. The amplification circuit 119, error-signal generation circuit 125, and objective-lens drive circuit 126 include the fourth circuit block that detects the error signal based on the output from the photodetector 111, to drive the objective lens based on the error signal.

Although omitted for depiction in FIG. 5, the optical information recording/reproducing apparatus 10 includes a positioner control circuit and a spindle control circuit. The positioner control circuit moves the optical head unit as a whole along the radial direction of the disk 108 by using a motor not shown in the figure. The spindle control circuit drives the spindle motor not illustrated, to control the disk 108 for rotation thereof. These members perform servo control for the focusing, tracking, positioner, and spindle. Circuits from the modulation circuit 116 to the semiconductor-laser drive circuit 118 that handle data recording, circuits from the amplification circuit 119 to the demodulation circuit 121 that handle data reproducing, circuits from the amplification circuit 119 to the magnification-variable-lens drive circuit 123 and liquid-crystal optical-element drive circuit 124 that handle compatibility, and circuits from the amplification circuit 119 to the objective-lens drive circuit 126 that handle the servo control are controlled by a controller not illustrated in the figure.

This exemplary embodiment uses the magnification-variable tens 105 and controls the magnification factor of the magnification-variable lens 105 so that light having a diameter corresponding to the type of the optical recording medium to be used is incident onto the objective lens 107. More specifically, in an optical recording medium of BD standard, since the light that contributes to the recording/reproducing is a light that is incident onto the interior of effective area of the objective lens 107, the magnification factor of the magnification-variable lens 105 is controlled so that the light having a diameter corresponding to the effective area is incident onto the objective lens 107. In an optical recording medium of BD standard, since the light that contributes to the recording/reproducing is a light that is incident onto the interior of circular area of the liquid-crystal optical element 112, the magnification factor of the magnification-variable lens 105 is controlled by so that the light having a diameter corresponding to the circular area of the liquid-crystal optical element 112 is incident onto the liquid-crystal optical element. In this way, useless light that does not contribute to the recording/reproducing can be reduced, whereby the utilization efficiency of light can be improved in any of the plurality of optical recording media having different optical characteristics used for the recording/reproducing.

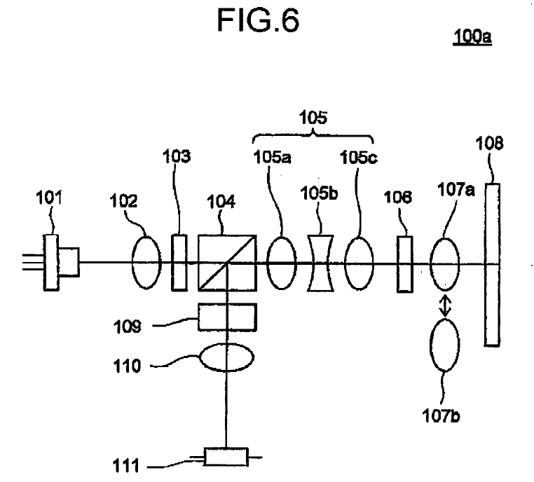

FIG. 6 shows the configuration of an optical head unit according to a second exemplary embodiment of the present invention. The optical head unit 100a of the present exemplary embodiment includes two objective lenses 107. One (objective lens 107a) of the objective lenses 107 is an objective lens used for recording/reproducing on an optical recording medium of BD standard, and the other (objective lens 107b) is that used for recording/reproducing on an optical recording medium of HD DVD standard. The objective lens 107a is designed so that the spherical aberration is corrected with respect to an optical recording medium of BD standard when the incident light is incident as a parallel light. The objective lens 107b is designed so that the spherical aberration is corrected with respect to an optical recording medium of HD DVD standard when the incident light is incident as a parallel light.

The light exiting from a semiconductor laser 101 that is the light source is collimated by the collimating lens 102, and is divided by the diffraction optical element 103 into three lights including zero-order light that is the main beam; and +first-order diffracted lights that are the subordinate beams. These lights are incident onto the polarization beam splitter 104 as P-polarized lights, substantially completely pass through the same, pass through the magnification-variable lens 105 that is configured by the convex lens 105a, concave lens 105b and convex lens 105c, are converted by the ¼-wavelength plate 106 from linearly-polarized lights into circularly-polarized lights, and are irradiated through the objective lens 107 onto the disk 108 that is an optical recording medium. Which one of the two objective lenses 107a and 107b is to be used as the objective lens 107 is determined depending on the type of the disk 108.

The reflected light of the main beam and reflected lights of the subordinate beams, which are reflected from the disk 108, pass through the objective lens 107 in the backward direction, converted by the ¼-wavelength plate 106 from the circularly-polarized lights into linearly-polarized lights that are perpendicular to the forward-path lights in the polarization direction, pass through the magnification-variable lens 105 in the backward direction, are incident onto the polarization beam splitter 104 as S-polarized lights, are substantially completely reflected by the polarization beam splitter 104, pass through the cylindrical lens 109 and convex lens 110, and are detected by the photodetector 111. Based on the output from the photoreceiving parts of the photodetector 111, a focus error signal, a tracking error signal, and an RF signal recorded on the disk 108 are detected. The focus error signal is detected by a known astigmatic technique, and the tracking error signal is detected by a known phase shift technique or differential push-pull technique.

Although omitted for depiction in FIG. 6, the optical head unit includes an objective-lens switching mechanism that switches the objective lens 107 to be used between the objective lens 107a and the objective lens 107b. If the disk 108 is an optical recording medium of BD standard, the objective-lens switching mechanism is driven to arrange the objective lens 107a within the optical path. The forward-path light that exits from the magnification-variable lens 105 as a parallel light is incident onto the objective lens 107a as the parallel light, and conversely, the backward-path light that exits from the objective lens 107a as a parallel light is incident onto the magnification-variable lens 105 as the parallel light. In this way, both the forward-path light and backward-path light are corrected in the spherical aberration thereof with respect to the disk 108. In this case, the numerical aperture of the objective lens 107a is set at 0.85 that is determined by the diameter of effective area of the objective lens 107a itself.

If the disk 108 is an optical recording medium of HD DVD standard, the objective-lens switching mechanism arranges the objective lens 107b within the optical path. In this case as well, the forward-path light that exits from the magnification-variable lens 105 as a parallel light is incident onto the objective lens 107b as the parallel light, and conversely, the backward-path light that exits from the objective lens 107b as a parallel light is incident onto the magnification-variable lens 105 as the parallel light. In this way, both the forward-path light and backward-path light are corrected in the spherical aberration thereof with respect to the disk 108. In this case, the numerical aperture of the objective lens 107b is set at 0.65 that is determined by the diameter of effective area of the objective lens 107b itself.

The magnification factor of the magnification-variable lens 105 is controlled depending on the type of the optical recording medium so that an optical beam having a diameter corresponding to the diameter of effective area of the objective lens 107a, 107b exits from the convex lens 105c. If a disk 108 of BD standard is used, the magnification-variable lens 105 is controlled to have a magnification factor that emits an optical beam having a diameter corresponding to the diameter of effective area of the objective lens 107a, and if a disk 108 of HD DVD standard is used, the magnification-variable lens 105 is controlled to have a magnification that emits an optical beam having a diameter corresponding to the diameter of effective area of the objective lens 107b. The ratio of the magnification factor of the magnification-variable lens 105 upon using an optical recording medium of BD standard to the magnification factor of the magnification-variable lens 105 upon using an optical recording medium of HD DVD standard is set substantially equal to the ratio of the diameter of effective area of the objective lens 107a to the diameter of effective area of the objective lens 107b.

In the present exemplary embodiment as well, the magnification-variable lens 105 described in the first and second examples can be used as such. It is assumed that the diameter of effective area of the objective lens 107a is set at 4 mm, and the diameter of effective area of the objective lens 107b is set at 2 mm. In this case, if the diameter of light incident onto the convex lens 105a is 4 mm, both the distance L1 between the convex lens 105a and the concave lens 105b and the distance L2 between the concave lens 105b and the convex lens 105c are controlled at 8 mm (FIG. 3A), for an optical recording medium of BD standard, to thereby set the magnification factor of the magnification-variable lens 105 at “1”, and allow a light corresponding to the diameter, 4 mm, of effective area of the objective lens 107a to exit from the magnification-variable lens 105. For an optical recording medium of HD DVD standard, the distances L1 and L2 are controlled at 10.5 mm and 3 mm, respectively (FIG. 3B), to thereby set the magnification factor of the magnification-variable lens 105 at “0.5”, and allow a light corresponding to the diameter, 2 mm, of effective area of the objective lens 107b to exit from the magnification-variable lens 105.

If the diameter of light incident onto the convex lens 105a is 2 mm, the distance L1 between the convex lens 105a and the concave lens 105b and the distance L2 between the concave lens 105b and the convex lens 105c are controlled at 3 mm and 10.5 mm, respectively (FIG. 4A), for an optical recording medium of BD standard, to thereby set the magnification factor of the magnification-variable lens 105 at “2”, and allow a light corresponding to the diameter, 4 mm, of effective area of the objective lens 107a to exit from the magnification-variable lens 105. For an optical recording medium of HD DVD standard, both the distances L1 and L2 are controlled at 8 mm (FIG. 4B), to set the magnification factor of the magnification-variable lens 105 at “1”, and allow a light corresponding to the diameter, 2 mm, of effective area of the objective lens 107b to exit from the magnification-variable lens 105.

If the disk 108 is an optical recording medium of BD standard, the effective light that contributes to the recording/reproducing is a light that is incident onto the interior of effective area of the objective lens 107a. On the other hand, if the disk 108 is an optical recording medium of HD DVD standard, the effective light that contributes to the recording/reproducing is a light that is incident onto the interior of effective area of the objective lens 107b. The optical head unit changes the magnification factor of the magnification-variable lens 105 depending on the type of disk 108, thereby allowing light corresponding to the diameter of effective area of the objective lens 107 to exit from the magnification-variable lens 105. For the use of different objective lenses 107 adapted to the respective types of disk 108, the magnification factor of the magnification-variable lens 105 is set depending on the diameter of effective area of the objective lens 107 to be used, thereby allowing light corresponding to the diameter of effective area of the objective lens 105 to exit from the magnification-variable lens 105 and improving the utilization efficiency of light for the optical recording medium of any standard.

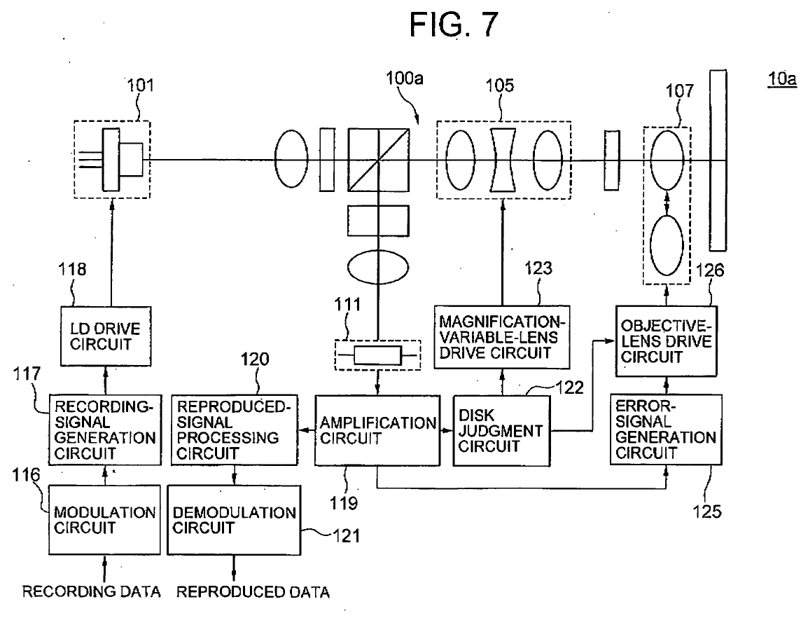

FIG. 7 shows the configuration of an optical information recording/reproducing apparatus which includes the optical head unit 100a shown in FIG. 6. The optical information recording/reproducing apparatus 10a includes, in addition to the optical head unit 100a, a modulation circuit 116, a recording-signal generation circuit 117, a semiconductor-laser drive circuit 118, an amplification circuit 119, a reproduced-signal processing circuit 120, a demodulation circuit 121, a disk judgment circuit 122, a magnification-variable-lens drive circuit 123, an error-signal generation circuit 125, and an objective-lens drive circuit 126.

The optical information recording/reproducing apparatus 10a of the present exemplary embodiment has a configuration obtained by omitting the liquid-crystal optical-element drive circuit 124 from the optical information recording/reproducing apparatus 10 of the first exemplary embodiment shown in FIG. 5. Operation of circuits from the modulation circuit 116 to the semiconductor-laser drive circuit 118 that handle data recording and operation of circuits from the amplification circuit 119 to the demodulation circuit 121 that handle data reproducing are similar to those of the optical information recording/reproducing apparatus 10 of the first exemplary embodiment.

The disk judgment circuit 122 judges whether the disk 108 is an optical recording medium of BD standard or an optical recording medium of HD DVD standard, based on the signal amplified in the amplification circuit 119. The magnification-variable-lens drive circuit 123 drives the magnification-variable lens 105 depending on the type of disk 108 judged by the disk judgment circuit 122 so that the magnification factor of the magnification-variable lens 105 has a specific value. More concretely, current is supplied to the stepping motor or SIDM, thereby controlling the distance between the lenses to set the magnification factor at the specific value.

The objective-lens drive circuit 126 selects an objective lens having a numerical aperture corresponding to the judged type of disk 108 from between the objective lenses 107a and 107b, based on the type of disk 108 judged by the disk judgment circuit 122, and drives the objective-lens switching mechanism not illustrated to arrange the selected objective lens 107 within the optical path. More concretely, if the disk 108 is an optical recording medium of BD standard, objective lens 107a is arranged within the optical path, whereas if the disk 108 is an optical recording medium of HD DVD standard, objective lens 107b is arranged within the optical path.

The error-signal generation circuit 125 generates the focus error signal and tracking error signal based on the signal amplified in the amplification circuit 119. The objective-lens drive circuit 126 supplies current to an actuator not shown based on the error signals generated in the error-signal generation circuit 125, to thereby drive, in addition to the above drive of the objective-lens switching mechanism, the objective lens 107a or objective lens 107b.

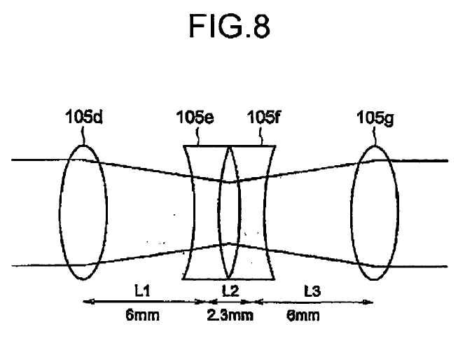

FIG. 8 shows a third example of the magnification-variable lens. This example can be used as the magnification-variable lens 105 in the first and second exemplary embodiments. In this example, the magnification-variable lens 105 is configured by four lenses including a convex lens 105d, a concave lens 105e, a concave lens 105f, and a convex lens 105g. L1 represents the distance between the convex lens 105d and the concave lens 105e, L2 represents the distance between the concave lens 105e and the concave lens 105f, and L3 represents the distance between the concave lens 105f and the convex lens 105g. The focal length of the convex lenses 105d and 105g is set at 18 mm, and the focal length of the concave lenses 105e and 105f is set at −12 mm. The thickness of each lens is assumed negligible for simplification of the description.

In this example, among the lenses configuring the magnification-variable lens 105, the location of convex lenses 105d and 105g is fixed, with the concave lenses 105e and 105f being moved along the optical axis direction, to change the magnification factor. As the mechanism for moving the lenses along the optical axis direction, a stepping motor or SIDM (smooth impact drive mechanism) may be used. In this example, due to fixing of the location of convex lenses 105d and 105g, the total length of the magnification-variable lens 105 is constant irrespective of the magnification factor of the magnification-variable lens 105. By using such a magnification-variable lens 105, the total length of the magnification-variable lens 105 can be reduced as compared to the first and second examples, to thereby reduce the size of the optical head unit.

The distance between the lenses is set such that L1=6 mm, L2=2.3 mm, and L3=6 mm, as shown in FIG. 8. In this case, the light incident onto the convex lens 105d as a parallel light exits from the convex lens 105g as the parallel light. In this configuration, the diameter of optical beam exiting from the convex lens 105g is equal to the diameter of optical beam incident onto the convex lens 105d, whereby the magnification factor of the magnification-variable lens 105 is “1”. Although not illustrated, in the case of L1=8.5 mm, L2=4.8 mm, and L3=1 mm, the light incident onto the convex lens 105d as a parallel light exits from the convex lens 105g as the parallel light. In this case, the diameter of the optical beam that exits from the convex lens 105g is half the diameter of the optical beam incident onto the convex lens 105d, whereby the magnification factor of the magnification-variable lens 105 is “0.5”. In the case of L1=1 mm, L2=4.8 mm, and L3=8.5 mm, the optical beam that is incident onto the convex lens 105d as a parallel light exits from the convex lens 105g as the parallel light, and the diameter of the optical beam that exits from the convex lens 105g is double the diameter of the optical beam incident onto the convex lens 105d, whereby the magnification factor of the magnification-variable lens 105 is “2”.

If the disk 108 is an optical recording medium of BD standard, the effective light that contributes to the recording/reproducing is a light that is incident onto the interior of the first area corresponding to the numerical aperture, 0.85, of the objective lens. Thus, the magnification factor of the magnification-variable lens 105 is controlled so that light having a diameter corresponding to the first area exits from the magnification-variable lens 105. More concretely, if the diameter of the first area is 4 mm and the diameter of the optical beam incident onto the convex lens 105d is 4 mm, the concave lenses 105e and 105f are moved along the optical axis direction so that the distance between the lenses is set at L1=6 mm, L2=2.3 mm, and L3=6 mm, thereby controlling the magnification factor of the magnification-variable lens 105 at “1”. If the diameter of the optical beam incident onto the convex lens 105d is 2 mm, the concave lenses 105e and 105f are moved along the optical axis direction so that the distance between the lenses is set at L1=1 mm, L2=4.8 mm, and L3=8.5 mm, thereby controlling the magnification factor of the magnification-variable lens 105 at “2”.

If the disk 108 is an optical recording medium of HD DVD standard, the effective light that contributes to the recording/reproducing is a light that is incident onto the interior of the second area corresponding to the numerical aperture, 0.65, of the objective lens. Thus, the magnification factor of the magnification-variable lens 105 is controlled so that light having a diameter corresponding to the second area exits from the magnification-variable lens 105. More concretely, if the diameter of the second area is 2 mm and the diameter of the optical beam incident onto the convex lens 105d is 4 mm, the concave lenses 105e and 105f are moved along the optical axis direction so that the distance between the lenses is set at L1=8.5 mm, L2=4.8 mm, and L3=1 mm, thereby controlling the magnification factor of the magnification-variable lens 105 at to “0.5”. If the diameter of the optical beam incident onto the convex lens 105d is 2 mm, the concave lenses 105e and 105f are moved along the optical axis direction so that the distance between the lenses is set at L1=6 mm, L2=2.3 mm, and L3=6 mm, thereby controlling the magnification factor of the magnification-variable lens 105 at “1”. In this way, the utilization efficiency of light in the optical head can be improved with respect to the optical recording media of any standards.

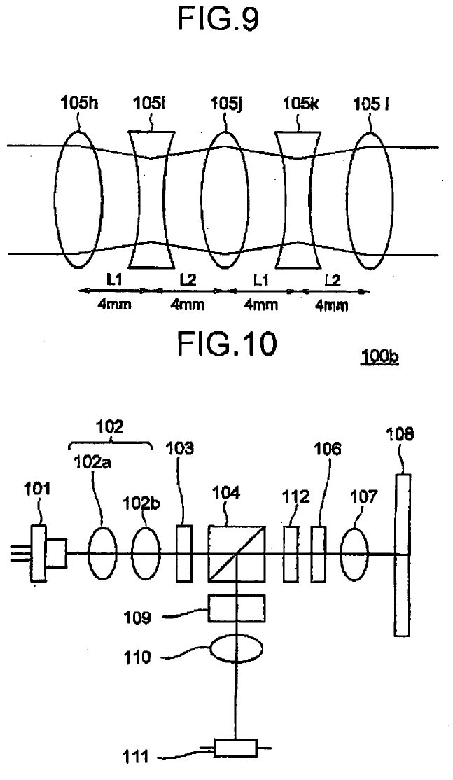

FIG. 9 shows a fourth example of the magnification-variable lens. This example can be used as the magnification-variable lens in the first and second exemplary embodiments. In this example, the magnification-variable lens 105 includes, consecutively from the light incident side with a convex lens 105h being the light incident side, the convex lens 105h, a concave lens 105i, a convex lens 105j, a concave lens 105k, and a convex lens 105l. L1 represents the distance between the convex lens 105h and the concave lens 105i and the distance between the convex lens 105j and the concave lens 105k. L2 represents the distance between the concave lens 105i and the convex lens 105j and the distance between the concave lens 105k and the convex lens 105l. The focal length of the convex lenses 105h and 105l is set at 18 mm, the focal length of the concave lenses 105i and 105k is set at −7 mm, and the focal length of the convex lens 105j is set at 9 mm. The thickness of each lens is assumed negligible for simplification of the description.

In this example, among the lenses that configure the magnification-variable lens 105, the location of the convex lenses 105h, 105j and 105l is fixed with the location of the concave lenses 105i and 105k being moved along the optical axis direction, to thereby change the magnification factor. As a mechanism that moves the lenses along the optical axis direction, a stepping motor or SIDM (smooth impact drive mechanism) can be used. In this example, as in the third example, the total length of the magnification-variable lens 105 is constant irrespective of the magnification factor of the magnification-variable lens 105, thereby reducing the total length of the magnification-variable lens 105.

The distance between the lenses is set at L1=4 mm and L2=4 mm, as shown in FIG. 9. In this case, the light that is incident onto the convex lens 105h as a parallel light exits from convex lens 105l as the parallel light. In this configuration, the diameter of the optical beam that exits from the convex lens 105l is equal to the diameter of the optical beam incident onto the convex lens 105h, whereby the magnification factor of the magnification-variable lens 105 is “1”. Although not illustrated in the figure, in the case of L1=6.444 mm and L L2=1.556 mm, the light that is incident onto the convex lens 105h as a parallel light exits from the convex lenses 105l as the parallel light. In this case, the diameter of the optical beam that exits from the convex lens 105l is half the diameter of the optical beam that is incident onto the convex lens 105h, whereby the magnification factor of the magnification-variable lens 105 is “0.5”. In the case of L1=1.556 mm and L2=6.444 mm, the diameter of the optical beam that is incident on the convex lens 105h as a parallel light exits from the convex lens 105l as the parallel light, and the diameter of the optical beam that exits from the convex lens 105l is double the diameter of the optical beam incident onto the convex lens 105h, whereby the magnification factor of the magnification-variable lens 105 is “2”.

If the disk 108 is an optical recording medium of BD standard, the effective light that contributes to the recording/reproducing is a light that is incident onto the interior of the first area corresponding to the numerical aperture, 0.85, of the objective lens. Thus, the magnification factor of the magnification-variable lens 105 is controlled so that light having a diameter corresponding to the first area exits from the magnification-variable lens 105. More concretely, if the diameter of the first area is 4 mm and the diameter of the optical beam incident onto the convex lens 105h is 4 mm, the concave lenses 105i and 105k are moved along the optical axis direction so that the distance between the lenses is set at L1=4 mm and L2=4 mm, thereby controlling the magnification factor of the magnification-variable lens 105 at “1”. If the diameter of the optical beam incident onto the convex lens 105h is 2 mm, the concave lenses 105i and 105k are moved along the optical axis direction so that the distance between the lenses is set at L1=1.556 mm and L2=6.444 mm, thereby controlling the magnification factor of the magnification-variable lens 105 at “2”.

If the disk 108 is an optical recording medium of HD DVD standard, the effective light that contributes to the recording/reproducing is a light that is incident onto the interior of the second area corresponding to the numerical aperture, 0.65, of the objective lens. Thus, the magnification factor of the magnification-variable lens 105 is controlled so that light having a diameter corresponding to the second area exits from the magnification-variable lens 105. More concretely, if the diameter of the second area is 2 mm and the diameter of the optical beam incident onto the convex lens 105h is 4 mm, the concave lenses 105i and 105k are moved along the optical axis direction so that the distance between the lenses is set at L1=6.444 mm and L2=1.556 mm, thereby controlling the magnification factor of the magnification-variable lens 105 at “0.5”. If the diameter of the optical beam incident onto the convex lens 105h is 2 mm, the concave lenses 105i and 105k are be moved along the optical axis direction so that the distance between the lenses is set at L1=4 mm and L2=4 mm, thereby controlling the magnification factor of the magnification-variable lens 105 at “1”. In this way, the utilization efficiency of light in the optical head can be improved with respect to the optical recording media of any standards.

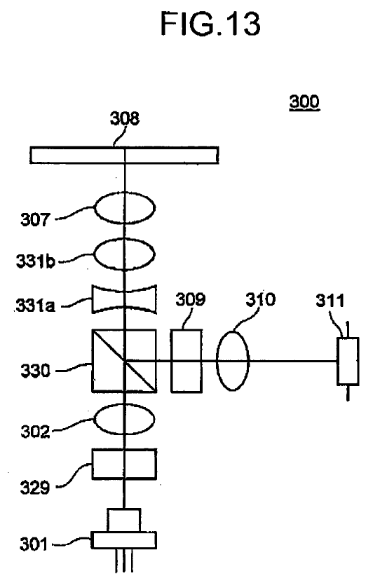

Here, in the first and second exemplary embodiments, the spherical aberration attributable to deviation of the protective layer thickness in the optical recording medium can be corrected, as in the optical head unit shown in FIG. 13. The correction of spherical aberration attributable to deviation of the protective layer thickness in the optical recording medium is performed by changing the magnification factor of the objective lens in accordance with the deviation of the protective layer thickness. The magnification-variable lens 105 has the function that corrects the spherical aberration attributable to deviation of the protective layer thickness in the optical recording medium. If the protective layer thickness of the disk 108 is equal to the design value, the distance between the lenses that configure the magnification-variable lens 105 is equal to the design value. In this case, the forward-path light that exits from the magnification-variable lens 105 assumes a parallel light. On the other hand, if the protective layer thickness of the disk is smaller than the design value, the distance between the lenses that configure the magnification-variable lens is changed from the design value so that the forward-path light that exits from the magnification-variable lens 105 assumes a convergent light having a specific convergence angle corresponding to deviation of the protective layer thickness. If the protective layer thickness is larger than the design value, the distance between the lenses that configure the magnification-variable lens 105 is changed so that the forward-path light that exits from the magnification-variable lens 105 assumes a divergent light having a specific divergence angle corresponding to deviation of the protective layer thickness. In this way, the spherical aberration attributable to deviation of the protective layer thickness of the disk 108 can be corrected.

FIG. 10 shows the configuration of an optical head unit according to a third exemplary embodiment of the present invention. In the optical head unit 100b of the present exemplary embodiment, the collimating lens 102 is configured by two convex lenses 102a and 102b. In the present exemplary embodiment, the collimating lens 102 is provided with the function of changing the diameter of the optical beam, whereby the magnification-variable lens 105 in the optical head unit 100 of the first example shown in FIG. 1 is not needed. In the present exemplary embodiment, since the magnification-variable lens is not needed separately from the collimating lens system, the cost of lens itself can be reduced.

The light exiting from the semiconductor laser 101 that is the light source is collimated by the collimating lens 102 that is configured by convex lenses 102a and 102b, and divided by the diffraction optical element 103 into a zero-order light that is the main beam, and ±first-order lights that are the subordinate beams. These lights are incident onto the polarization beam splitter 104 as P-polarized lights, substantially completely pass through the same, pass through the liquid-crystal optical element 112, are converted by the ¼-wavelength plate 106 from linearly-polarized lights to circularly-polarized lights, and are focused by the objective lens 107 onto the disk 108 that is the optical recording medium.

The reflected light of the main beam and reflected light of the subordinate beams that are reflected by the disk 108 pass through the objective lens 107 in the backward direction, are converted by the ¼-wavelength plate 106 from the circularly-polarized lights into linearly-polarized lights that are perpendicular in the polarization direction thereof to that in the forward path, pass through the liquid-crystal optical element 112 in the backward direction, and are incident onto the polarization beam splitter 104 as S-polarized lights. The lights incident onto the polarization beam splitter 104 as the S-polarized lights are substantially completely reflected thereby, pass through the cylindrical lens 109 and convex lens 110, and are received by the photodetector 111. Based on the output from the photoreceiving parts of this photodetector 111, a focus error signal, a tracking error signal, and an RF signal are detected. The focus error signal is detected by a known astigmatic technique, the tracking error signal is detected by a known phase shift technique or differential push-pull technique.

The optical head unit 100b is configured as an optical head unit that is capable of recording and reproducing on any of an optical recording medium of HD DVD standard and an optical recording medium of BD standard. The objective lens 107 is designed so that the spherical aberration is corrected for an optical recording medium of BD standard when a parallel light is incident onto the objective lens. It is also designed so that the spherical aberration is corrected for an optical recording medium of HD DVD standard when a divergent light having a specific divergence angle is incident onto the objective lens.

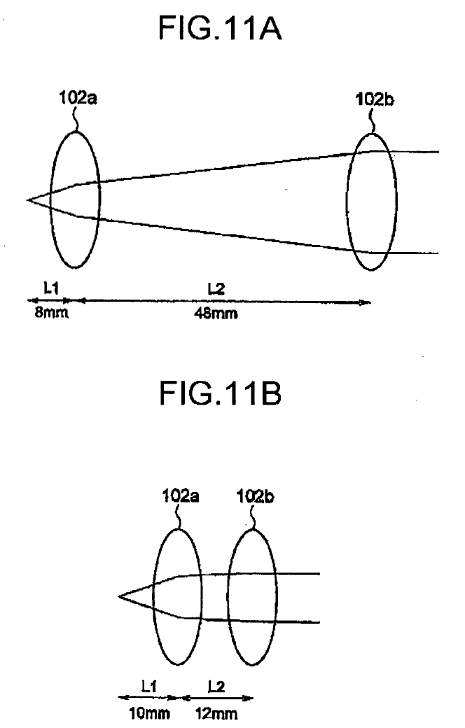

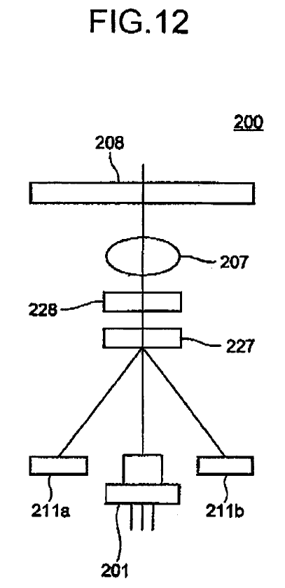

FIGS. 11A and 11B show an example of the collimating lens. L2 represents the distance between the convex lens 102a and the convex lens 102b that configure the collimating lens 102, and L1 represents the distance between the emitting point of the semiconductor laser 101 and the convex lens 102a that is nearer to the light source. The focal length of the convex lens 102a is set at 12 mm, the focal length of the convex lens 102b is set at 72 mm, and the thickness of each lens is assumed negligible for simplification of the description. It is assumed tan θ=0.08333 for the θ that is half the divergence angle of the beam incident onto the convex lens 102a.

In the collimating lens 102, both the convex lenses 102a and 102b that configure the collimating lens are moved along the optical axis direction, to thereby change the combined focal length. As the mechanism that moves the convex lenses 102a and 102b along the optical axis direction, a stepping motor or SIDM (smooth impact drive mechanism) can be used. In the case of L1=8 mm and L2=48 mm, as shown in FIG. 11A, the light incident onto the convex lens 102a as a divergent light exits from the convex lens 102b as a parallel light. In this case, the focal length of the collimating lens 102 is 24 mm. On the other hand, in the case of L1=10 mm and L2=12 mm, as shown in the FIG. 11B, the light incident onto the convex lens 102a as a divergent light exits from the convex lens 102b as a parallel light, and the focal length of the collimating lens 102 in this case is 12 mm.

If the disk 108 is an optical recording medium of BD standard, the effective light that contributes to the recording/reproducing is a light that is incident onto the interior of effective area of the objective lens 107. On the other hand, if the disk 108 is an optical recording medium of HD DVD standard, the effective light that contributes to the recording/reproducing is a light that is incident onto the interior of circular area of the liquid-crystal optical element 112. Here, it is assumed that the diameter of effective area of the objective lens 107 is 4 mm, and the diameter of circular area of the liquid-crystal optical element 112 is 2 mm. If the disk 108 is an optical recording medium of BD standard, the convex lenses 102a and 102b that configure the collimating lens 102 are moved along the optical axis direction so that the combined focal length of the collimating lens 102 is set at 24 mm, and the diameter of the optical beam that exits from the convex lens 102b is set at 4 mm that is equal to the diameter of effective area of the objective lens 107. If the disk 108 is an optical recording medium of HD DVD standard, the convex lenses 102a and 102b that configure the collimating lens 102 are moved along the optical axis direction so that the combined focal length of the collimating lens 102 is set at 24 mm, and the diameter of the optical beam that exits from the convex lens 102b is set at 2 mm that is equal to the diameter of circular area of the liquid-crystal optical element 112. In this way, by changing the diameter of the optical beam that exits from the collimating lens 102 depending on the type of disk 108, a higher utilization efficiency of light can be obtained again with respect to the optical recording media of any standards.

An optical information recording/reproducing apparatus that includes the optical head unit 100b of the present exemplary embodiment will be described. The optical information recording/reproducing apparatus of the present exemplary embodiment includes a collimating-lens-system drive circuit, instead of the magnification-variable-lens drive circuit 123 in the optical information recording/reproducing apparatus 10 of the first exemplary embodiment shown in FIG. 5. More specifically, the apparatus includes, in addition to the optical head unit 100b, a modulation circuit 116, a recording-signal generation circuit 117, a semiconductor-laser drive circuit 118, an amplification circuit 119, a reproduced-signal processing circuit 120, a demodulation circuit 121, a disk judgment circuit 122, a collimating-lens-system drive circuit, a liquid-crystal optical-element drive circuit 124, an error-signal generation circuit 125, and an objective-lens drive circuit 126. Operation of circuits from the modulation circuit 116 to the semiconductor-laser drive circuit 118 that handle data recording, circuit from the amplification circuit 119 to the demodulation circuit 121 that handle data reproducing is similar to the operation in the optical information recording/reproducing apparatus in the first exemplary embodiment (FIG. 5).

The disk judgment circuit 122 judges whether the disk 108 is an optical recording medium of BD standard or an optical recording medium of HD DVD standard based on the signal amplified in the amplification circuit 119. The collimating-lens-system drive circuit that drives the collimating lens 102 supplies current to the stepping motor or SIDM that drives the lenses configuring the collimating lens 102 based on the judgment result in the disk judgment circuit 122, to thereby drive the collimator lens 102 so that the combined focal length of the collimating lens 102 assumes a specific value that is determined in accordance with the medium type. The liquid-crystal optical-element drive circuit 124 supplies a voltage to the liquid-crystal optical element 112 based on the judgment result in the disk judgment circuit 122, to drive the liquid-crystal optical element 112 so that the magnification factor and numerical aperture of the objective lens 107 assumes a specific value that is determined in accordance with the medium type.

The error-signal generation circuit 125 generates the focus error signal and tracking error signal based on the signal amplified in the amplification circuit 119. The objective-lens drive circuit 126 supplies current corresponding to the error signals to the actuator that drives the objective lens, to thereby drive the objective lens 107 based on the error signals generated in the error-signal generation circuit 125.

Next, a fourth exemplary embodiment will be described. The optical head unit of the fourth exemplary embodiment of the present invention has a configuration wherein the collimating lens 102 is configured by the convex lens 102a and convex lens 102b while omitting the magnification-variable lens 105 from the optical head unit 100a of the second exemplary embodiment shown in FIG. 6. In the present exemplary embodiment, as in the second exemplary embodiment, the objective lens 107a for use in data reproducing on an optical recording medium of BD standard and the objective lens 107b for use in data recording on an optical recording medium of an HD DVD standard are used while switching therebetween depending on the type of the disk 108. As the collimating lens 102, the example shown in FIG. 11 can be used, as in the third exemplary embodiment.

If the disk 108 is an optical recording medium of BD standard, the effective light that contributes to the recording/reproducing is a light that is incident onto the interior of effective area of the objective lens 107a. On the other hand, if the disk 108 is an optical recording medium of HD DVD standard, the effective light that contributes to the recording/reproducing is a light that is incident onto the interior of effective area of the objective lens 107b. Here, it is assumed that the diameter of effective area of objective lens 107a is 4 mm, and the diameter of effective area of objective lens 107b is 2 mm. If the disk 108 is an optical recording medium of BD standard, the convex lenses 102a and 102b that configure the collimating lens 102 are moved along the optical axis direction so that the combined focal length of the collimating lens 102 assumes 24 mm, whereby the diameter of the optical beam that exits from the convex lens 102b is 4 mm that is equal to the diameter of effective area of the objective lens 107a. If the disk 108 is an optical recording medium of HD DVD standard, the convex lenses 102a and 102b that configure the collimating lens 102 are moved along the optical axis direction so that the combined focal length of the collimating lens 102 assumes 24 mm, whereby the diameter of the optical beam that exits from the convex lens 102b is 2 mm that is equal to the diameter of effective area of the objective lens 107b. In this way, by changing the diameter of the optical beam that exits from the collimating lens 102 in accordance with the type of disk 108, a higher utilization efficiency of light is obtained again with respect to the optical recording media of any standards.

An optical information recording/reproducing apparatus including the optical head unit of the present exemplary embodiment will be described. The optical information recording/reproducing apparatus of the present exemplary embodiment includes a collimating-lens-system drive circuit instead of the magnification-variable-lens drive circuit 123 in the optical information recording/reproducing apparatus 10a of the second exemplary embodiment shown in FIG. 7. More specifically, the apparatus includes, in addition to the optical head unit of the present exemplary embodiment, a modulation circuit 116, a recording-signal generation circuit 117, a semiconductor-laser drive circuit 118, an amplification circuit 119, a reproduced-signal processing circuit 120, a demodulation circuit 121, a disk judgment circuit 122, a collimating-lens-system drive circuit, an error-signal generation circuit 125 and an objective-lens drive circuit 126. Operation of circuits from the modulation circuit 116 to the semiconductor-laser drive circuit 118 that handle data recording, and circuits from the amplification circuit 119 to the demodulation circuit 121 that handle data reproducing are similar to the operation in the optical information recording/reproducing apparatus 10 of the first exemplary embodiment (FIG. 5).

The disk judgment circuit 122 judges whether the disk 108 is an optical recording medium of BD standard or an optical recording medium of HD DVD standard, based on the signal amplified in the amplification circuit 119. The collimating-lens-system drive circuit supplies current to the stepping motor or SDIM that drives the collimating lens 102 based on the judgment result in the disk judgment circuit 122 so that the combined focal length of the collimating lens 102 has the specific value corresponding to the medium type, to thereby drive the collimating lens 102. The objective-lens drive circuit 126 drives the objective-lens switching mechanism that switches the objective lens to be used between the objective lens 107a and the objective lens 107b based on the judgment result in the disk judgment circuit 122, to arrange within the optical path the objective lens having a numerical aperture corresponding to the medium type from between the objective lens 107a and objective lens 107b.

The error-signal generation circuit 125 generates the focus error signal and tracking error signal based on the signal amplified in the amplification circuit 119. The objective-lens drive circuit 126 supplies current corresponding to the error signals to the actuator that drives the objective lens 107a or objective lens 107b based on the error signals generated in the error-signal generation circuit 125, to drive the objective lens 107a or objective lens 107b, in addition to drive of the objective-lens switching mechanism.

In the third and fourth exemplary embodiments, the spherical aberration attributable to deviation of the protective layer thickness in the optical recording medium can be corrected as in the optical head unit shown in FIG. 13. Correction of the spherical aberration attributable to deviation of the protective layer thickness in the optical recording medium is performed by changing the magnification factor of the objective lens based on deviation of the protective layer thickness. The collimating lens 102 also has the function of correcting the spherical aberration attributable to deviation of the protective layer thickness in the optical recording medium. If the protective layer thickness of the disk 108 is equal to the design value, the distance between the lenses that configure the collimating lens 102 is made equal to the design value. In this case, the forward-path light emitted from the collimating lens 102 assumes a parallel light. On the other hand, it the protective layer thickness of the disk 108 is smaller than the design value, the distance between the lenses that configure the collimating lens 102 is changed from the design value so that the forward-path light that exits from the collimating lens 102 assumes a convergent light having a specific convergence angle corresponding to deviation of the protective layer thickness. Further, if the protective layer thickness of the disk 108 is smaller than the design value, the distance between the lenses that configure the collimating lens 102 is changed from the design value so that the forward-path light that exits from the collimating lens 102 assumes a divergent light having a specific divergence angle corresponding to deviation of the protective layer thickness. In this way, the spherical aberration attributable to the protective layer thickness can be corrected.

Although the collimating lens 102 is provided separately from the magnification-variable lens 105 in the first and second exemplary embodiments, it is possible to employ a single lens that functions as both the magnification-variable lens 105 and collimating lens 102. For example, suppose that the collimating lens is shifted to the space between the polarization beam splitter 104 and the magnification-variable lens 105, and the collimating lens is unified with another lens nearest to the collimating lens among the lenses in the magnification-variable lens. In this case, the convex lens 110 is replaced by a concave lens. By employing such a configuration, the number of lenses used therein can be reduced.

In the first and second examples of the magnification-variable lens (FIG. 3, FIG. 4), each of the convex lens 105a, concave lens 105b and convex lens 105c configures a single lens group, whereby the magnification-variable lens 105 is configured by three lens groups. On the other hand, another example may be considered wherein at least one lens group among the three lens groups is configured by a plurality of lenses instead of the single lens. In the third example (FIG. 8), each of the convex lenses 105d, concave lens 105e, concave lens 105f and convex lens 105g configures a single lens group, whereby the magnification-variable lens 105 is configured by four lens groups. For the third example of the magnification-variable lens, another example may be considered wherein at least one lens group among the four lens groups is also configured by a plurality of lenses.

In the fourth example of the magnification-variable lens (FIG. 9), each of the convex lenses 105h, concave lens 105i, convex lens 105j, concave lens 105k and convex lens 105l configures a single lens group, whereby the magnification-variable lens 105 is configured by five lens groups. On the other hand, another example may be considered wherein at least one lens group among the five lens groups is configured by a plurality of lenses instead of the single lens. If at least one lens group among the three or more lens groups that configure the magnification-variable lens is configured by a plurality of lenses, aberrations, such as astigmatism aberration, coma aberration, and spherical aberration, can be reduced.

In the example of the collimating lens (FIG. 11), each of the convex lens 102a and convex lens 102b configures a single lens group, whereby the collimating lens is configured by two lens groups. On the other hand, another example may be considered wherein at least one lens group of the two lens groups that configure the collimating lens is configured by a plurality of lenses instead of the single lens, aberrations, such as astigmatism aberration, coma aberration, and spherical aberration, can be reduced.

In the first through fourth exemplary embodiments, the optical information recording/reproducing apparatus that performs recording/reproducing on a disk is described; however, the optical disk drive mounting thereon the optical head unit of the present invention may be an optical information reproducing apparatus that performs only reproducing. If the optical disk drive is configured as the optical information reproducing apparatus, the semiconductor laser 101 is not driven based on the recording signal by the semiconductor-laser drive circuit, and is driven so that the amount of emitted light is constant.

The optical head units of the above exemplary embodiments include a functional lens that has the function of changing the diameter of light incident onto the objective lens, wherein the diameter of light incident onto the objective lens is controlled by the functional lens depending on the optical recording medium to be used. There is a case wherein, during the recording/reproducing on recording media of a plurality of types for which different optical conditions are used in the recording/reproducing, the diameter of light effective to the recording/reproducing is different depending on the type of the recording medium. Thus, the functional lens is controlled to control the diameter of light incident onto the objective lens so that the diameter of light incident onto the objective lens is equal to the diameter of light effective to the recording/reproducing on the optical recording medium that is the target for the recording/reproducing. Control of the diameter of light incident onto the objective lens depending on the type of the optical recording medium in this way reduces the waste light that does not contribute to recording/reproducing during the recording/reproducing on the optical recording medium, to thereby improve the utilization efficiency of light.

As described heretofore, the optical head unit of the present invention may have the following aspects.

A configuration may be employed wherein the functional lens is configured by at least two lens groups, and a distance between the lens groups is controlled to control the diameter of the optical beam incident onto the objective lens. In this case, a configuration may be employed wherein at least two of the lens groups are movable along an optical axis direction, and position-controlled along the optical axis direction to control the distance between the lens groups. The lens group includes at least one lens. The function of the functional lens that changes the diameter of light incident onto the objective lens can be achieved by moving the position of the lens group along the optical axis direction, to adjust the distance between the lens groups.

A configuration may be employed wherein the functional lens is a magnification-variable lens that has a function of changing a ratio of a diameter of an optical beam incident thereto from the light source to a diameter of the optical beam that exits therefrom toward the objective lens. In this case, by changing the ratio of the diameter of the optical beam incident from the light source to the diameter of the optical beam that exits toward the objective lens in the magnification-variable lens, the diameter of light incident onto the objective lens can be made equal to the diameter of the light effective to the recording/reproducing on the optical recording medium that is the target for the recording/reproducing, thereby improving the utilization efficiency of light with respect to the plurality of types of optical recording medium.

A configuration may be employed wherein the functional lens includes at least two convex lenses and at least one concave lens. A variety of configurations may be considered as the configuration of the magnification-variable lens, and for example, the magnification-variable lens may include, consecutively from the light source side, a convex lens, a concave lens and a convex lens. In an alternative, the magnification-variable lens may include, consecutively from the light source side, a convex lens, a concave lens, a concave lens and a convex lens, or include, consecutively from the light source side, a convex lens, a concave lens, a convex lens, a concave lens and a convex lens. In these configurations, each lens may be configured by a combination of a plurality of lenses.

A configuration may be employed wherein the functional lens is a collimating lens that collimates a divergent light emitted from the light source. In this case, by changing the diameter of light incident onto the objective lens by using the collimating lens that collimates the light from the light source, provision of a functional lens, such as the magnification-variable lens, is not needed other than the collimating lens, thereby reducing the cost for the optical head unit.

A configuration may be employed wherein the functional lens includes two convex lenses. In this case, by employing a configuration wherein the two convex lenses are configured movable to adjust the position in the optical axis direction and controlling the distance between the light source and the two convex lenses and the distance between the two convex lenses depending on the type of the optical recording medium, the diameter of light incident onto the objective lens can be changed depending on the optical recording medium. In this case as well, each convex lens may be configured by a combination of a plurality of lenses.

A configuration may be employed wherein the plurality of types of optical recording medium includes a first optical recording medium that uses an optical condition corresponding to an objective lens having a first numerical aperture, and a second optical recording medium that uses an optical condition corresponding to an objective lens having a second numerical aperture. In this case, a configuration may be employed wherein the functional lens passes therethrough an optical beam having a diameter corresponding to a diameter of the effective area of the objective lens having the first numerical aperture, upon using the first optical recording medium, whereas the functional lens passes therethrough an optical beam having a diameter corresponding to a diameter of the effective area of the objective lens having the second numerical aperture, upon using the second optical recording medium. In the case of employing such a configuration, upon recording/reproducing on the first optical recording medium, the diameter of light incident onto the objective lens is made equal to the diameter of light effective to the recording/reproducing on the first optical recording medium to obtain a higher utilization efficiency of light with respect to the first optical recording medium. In addition, upon recording/reproducing on the second optical recording medium, the diameter of light incident onto the objective lens is made equal to the diameter of light effective to the recording/reproducing on the second optical recording medium to obtain a higher utilization efficiency of light with respect to the second optical recording medium.

A configuration may be employed that further includes a liquid-crystal optical element disposed between the objective lens and the functional lens, wherein the liquid-crystal optical element passes therethrough light that exits from the functional lens upon using the first optical recording medium, acts as a concave lens with respect to light within a circular area corresponding to an effective area of an objective lens having a second numerical aperture and diffracts light outside the circular area upon using the second optical recording medium. In this case, the objective lens is configured by an objective lens that has an effective area corresponding to the first numerical aperture, is designed so that the spherical aberration is corrected with respect to the first optical recording medium when a parallel light is incident, and is designed so that the spherical aberration is corrected with respect to the second optical recording medium when a divergence light having the specific divergence angle is incident. Upon recording/reproducing on the first optical recording medium, the functional lens passes therethrough a light having a diameter corresponding to the effective area of the objective lens, and the liquid-crystal optical element passes therethrough the light emitted from the functional lens to be incident onto the objective lens. Upon recording/reproducing on the second optical recording medium, the functional lens passes there through a light corresponding to the diameter of the circular area of the liquid-crystal optical element corresponding to the second numerical aperture, and the liquid-crystal optical element passes therethrough the light within the circular area as a light having the specific divergence angle. Comparing the diameter of effective area of the objective lens against the diameter of circuit area of the liquid-crystal optical element, the diameter of the circular is smaller than the diameter of effective area of the objective lens, and thus upon emitting light corresponding to the diameter of effective area of the objective lens to the liquid-crystal optical element during recording/reproducing on the second optical recording medium, the light outside the circular area is diffracted and not incident onto the objective lens as the effective light for the objective lens. On the other hand, the configuration wherein the diameter of light that exits from the functional lens is made equal to the diameter corresponding to the circular area of the liquid-crystal optical element upon recording/reproducing on the second optical recording medium can reduce the light that is not incident as the effective light onto the objective lens due to the diffraction, thereby obtaining a higher utilization efficiency of light with respect to the second optical recording medium. In addition, by emitting the divergent light having the specific divergence angle from the liquid-crystal optical element upon recording/reproducing on the optical recording medium, the spherical aberration can be corrected with respect to the second optical recording medium while using the same objective lens with respect to both the first optical recording medium and second optical recording medium.

A configuration may be employed wherein an objective lens having a first numerical aperture and an objective lens having a second numerical aperture are provided therein, and the objective, lens having the first numerical aperture and the objective lens having the second numerical aperture are switched therebetween depending on the optical recording medium used therein. In the above configuration, by using the liquid-crystal optical element, the numerical aperture of the objective lens is changed between the first numerical aperture and the second numerical aperture depending on the recording/reproducing on the first optical recording medium or the recording/reproducing on the second optical recording medium while using a single objective lens. On the other hand, by preparing two objective lenses including an objective lens having the first numerical aperture and an objective lens having the second numerical aperture, the objective lens used therein may be switched depending on the optical recording medium. Upon recording/reproducing on the first optical recording medium, the objective lens having the first numerical aperture is used to allow the functional lens to emit a light having a diameter corresponding to the effective area of the objective lens having the first numerical aperture toward the objective lens, thereby obtaining a higher utilization efficiency of light with respect to the first optical recording medium. Upon recording/reproducing on the second optical recording medium, the objective lens having the second numerical aperture is used to allow the functional lens to emit a light having a diameter corresponding to the diameter of effective area of the objective lens having the second numerical aperture, thereby obtaining a higher utilization efficiency of light with respect to the second optical recording medium.

While the invention has been particularly shown and described with reference to exemplary embodiment and modifications thereof, the invention is not limited to these embodiment and modifications. It will be understood by those of ordinary skill in the art that various changes in form and details may be made therein without departing from the spirit and scope of the present invention as defined in the claims.

This application is based upon and claims the benefit of priority from Japanese patent application No. 2006-317324 filed on Nov. 24, 2006, the disclosure of which is incorporated herein in its entirety by reference.

1. An optical head unit for use in recording/reproducing on a plurality of types of optical recording medium for which different optical conditions are used in the recording/reproducing, said optical head unit comprising:
a light source;
an objection lives that focuses light from said light source to form a focused spot on an optical recording medium including a track;
a functional lens disposed between said light source and said objective lens and having a function of changing a diameter of light incident onto said objective lens;
a photodetector that receives light reflected from the optical recording medium,
where said functional lens is controlled depending on the type of the optical recording medium to be used, thereby controlling the diameter of an optical beam incident onto said objective lens.

2. The optical head unit according to claim 1, wherein said functional lens is configured by at least two lens groups, and a distance between said lens groups is controlled to control the diameter of the optical beam incident onto said objective lens.

3. The optical head unit according to claim 2, wherein at least two of said lens groups are movable along an optical axis direction, and position-controlled along said optical axis direction to control the distance between said lens groups.

4. The optical head unit according to claim 1, wherein said functional lens is a magnification-variable lens that has a function of changing a ratio of a diameter of an optical beam incident from said light source to a diameter of said optical beam that exists toward said objective lens.

5. The optical head unit according to claim 4, wherein said functional lens includes at least two convex lenses and at least one concave lens.

6. The optical head unit according to claim 1, wherein said functional lens is a collimating lens that collimates a divergent light emitted from said light source.

7. The optical head unit according to claim 6, wherein said functional lens includes two convex lenses.

8. The optical head unit according to claim 1, wherein said plurality of types of optical recording medium include a first optical recording medium that uses an optical condition corresponding to an objective lens having a first numerical aperture, and a second optical recording medium that uses an optical condition corresponding to an objective lens having a second numerical aperture.

9. The optical head unit according to claim 8, wherein said functional lens passes therethrough an optical beam having a diameter corresponding to a diameter of an effective area of said objective lens having said first numerical aperture upon using said first optical recording medium, and said lens system passes therethrough an optical beam having a diameter corresponding to a diameter of an effective area of said objective lens having said second numerical aperture upon using said second optical recording medium.

10. The optical head unit according to claim 8, further comprising a liquid-crystal optical element disposed between said objective lens and said functional lens, wherein said liquid-crystal optical element passes therethrough light that exists from said functional lens upon using said first optical recording medium, acts as a concave lens with respect to light within a circular area corresponding to an effective area of an objective lens having a second numerical aperture and diffracts light outside said circular area upon using said second optical recording medium.

11. The optical head unit according to claim 8, wherein an objective lens having a first numerical aperture and an objective lens having a second numerical aperture are provided therein, and said objective lens having said first numerical aperture and said objective lens having said second numerical aperture are switched therebetween depending on said optical recording medium used therein.

12. An optical information recording/reproducing apparatus, comprising:
the optical head unit according to claim 1;
a first circuit block that drives said light source;
a second circuit block that detects an RF signal recorded on said optical recording medium based on an output from said photodetector;
a third circuit block that drives said functional lens so that said diameter of said optical beam changes depending on a medium type of said optical recording medium to be used; and
a fourth circuit block that detects a focus error that represents a positional deviation of said focused spot along said optical axis direction with respect to said track and a tracking error signal that represents a positional deviation of said focused spot perpendicular to said track within a plane perpendicular to said optical axis based on said output from said photodetector, and drives said objective lens based on said focus error signal and said tracking error signal.
